(19) United States
(12) Patent Application Publication
(10) Pub. No.: US 2017/0046346 A1
(43) Pub. Date: Feb. 16, 2017

(54) Method and System for Characterizing a User's Reputation

(71) Applicant: Juji, Inc., Saratoga, CA (US)

(72) Inventors: Michelle Xue Zhou, Saratoga, CA (US); Huahai Yang, San Jose, CA (US)

(21) Appl. No.: 14/855,836

(22) Filed: Sep. 16, 2015

Related U.S. Application Data
(60) Provisional application No. 62/204,858, filed on Aug. 13, 2015.

(51) Int. Cl. G06F 17/30

(52) U.S. Cl. CPC G06F 17/3053; G06F 17/30569; G06F 17/30345

(57) ABSTRACT

The present teaching relates to characterizing a user's reputation. In one example, information related to a plurality of users is obtained from one or more sources. The information is obtained with respect to at least one type of online activity. The information is transformed into one or more human traits of the plurality of users. Each human trait for each of the plurality of users is estimated based at least partially on the information related to the user. Each human trait is associated with at least one score. A reputation of a user included in the plurality users is estimated with respect to the user's one or more human traits, based on at least one score associated with each of one or more human traits of the user and at least one score associated with each of the one or more human traits of the plurality of users.

### CROSS-REFERENCE TO RELATED APPLICATION

The present application claims priority to U.S. Provisional Patent Application No. 62/204,858, filed Aug. 13, 2015, entitled “METHOD AND SYSTEM FOR CHARACTERIZING A USER'S REPUTATION,” which is incorporated herein by reference in its entirety.

### BACKGROUND

1. Technical Field

The present teaching relates to methods, systems, and programming for characterizing a users reputation.

2. Discussion of Technical Background

Nowadays, people have many means to engage with one another, in person of online. Knowing better about the people to be engaged can facilitate the success of their engagements. Similarly, in today's peer-to-peer economy (i.e., sharing economy) where people engage with one another in economic transactions, it is important to understand one another s characteristics and qualities.

Although the advances in social web (e.g., Facehook, LinkedIn, Twitter) have provided more opportunities for people to express themselves and engage with one another, few sites provide users with adequate information about one another's characteristics and qualities. As a result, in today's peer-to-peer engagement, one only blindly trusts information from others without knowing, detailed character information of the others. Such “blindness” not only may prevent users from effectively engaging with one another, but also may hinder a system administrator from effectively managing an engagement system.

Therefore, there is a need to develop techniques for characterizing a user to overcome the above drawbacks.

### SUMMARY

The present teaching relates to methods, systems, and programming for characterizing a user's reputation.

In one example, a method, implemented on a machine having at least one processor, storage, and a communication platform connected to a network for characterizing a user's reputation, information related to a plurality of users is obtained from one or more sources. The information is obtained with respect to at least one type of online activity. The information is transformed into one or more human traits of the plurality of users. Each human trait for each of the plurality of users is estimated based at least partially on the information related to the user. Each human trait is associated with at least one score. A reputation of a user included in the plurality of users is estimated with respect to the user's one or more human traits, based on at least one score associated with each of one or more human traits of the user and at least one score associated with each of the one or more human traits of the plurality of users.

In a different example, a system having at least one processor, storage, and a communication platform connected to a network for characterizing a user's reputation is disclosed. The system comprises a data input selector configured for obtaining, from one or more sources, information related to a plurality of users, wherein the information is obtained with respect to at least one type of online activity; a human trait determiner configured for transforming the information into one or more human traits of the plurality of users, wherein each human trait for each of the plurality of users is estimated based at least partially on the information related to the user and each human trait is associated with at least one score: and a character badge determiner configured for estimating, with respect to a user's one or more human traits, a reputation of the user included in the plurality of users based on at least one score associated with each of one or more human traits of the user and at least one score associated with each of the one or more human traits of the plurality of users.

Other concepts relate to software for implementing the present teaching on characterizing a user's reputation. A software product, in accord with this concept, includes at least one machine-readable non-transitory medium and information carried by the medium The information carried by the medium may be executable program rode data, parameters in association with the executable program code, and/or information related to a user, a request, content, or information related to a social group, etc.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein;

FIG. 1 is illustrates an exemplary diagram of an engagement facilitation system, according to an embodiment of the present teaching;

FIG. 2 illustrates content in databases for characterizing a user's reputation, according to an embodiment of the present teaching;

FIG. 3 illustrates content in a knowledge database, according to an embodiment of the present teaching;

FIG. 4 illustrates an exemplary diagram of a Character Badge Determiner, according to an embodiment of the present teaching;

FIG. 5 shows a flowchart of an exemplary process performed by a Character Badge Determiner, according to an embodiment of the present teaching;

FIG. 6 illustrates an exemplary diagram of a Character-based Engagement Facilitator, according to an embodiment of the present teaching;

FIG. 7 is a flowchart of an exemplary process performed by a Character-based Engagement Facilitator, according to an embodiment of the present teaching;

FIG. 8 illustrates an exemplary diagram of a Character Badge Manager, according to an embodiment of the present teaching;

FIG. 9 is a flowchart of an exemplary process performed by a Character Badge Manager, according to an embodiment of the present teaching;

FIG. 10 depicts the architecture of a mobile device which can he used to implement a specialized system incorporating the present teaching;

FIG. 11 depicts the architecture of a computer which can be used to implement a specialized system incorporating the present teaching; and

FIG. 12 is a high level depiction of an exemplary networked environment for facilitating engagement, according to an embodiment of the present teaching.

### DETAILED DESCRIPTION

In the following detailed description, numerous specific details are set forth by way of examples in order to provide a thorough understanding of the relevant teachings. However, it should he apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of characterizing a user. This present teaching discloses methods and systems that automatically determine a person's one or more character badges and utilize these badges to facilitate peer-to-peer engagements in both online and physical settings. A character badge manifests a person's one or more unique qualities in a given context (e.g., a person's buyer personality vs, dating personality) and helps establish the person's reputation in the specific context. Utilities of these character badges are also revealed to show how the badges may facilitate peer-to-peer engagements by helping people discover more trustworthy, personalized information, and engage with those with a particular character. Furthermore, the present teaching includes methods that manage character badges to ensure the quality of the badges, such as their freshness, authenticity, and integrity, and protect the integrity of engagements (e.g., detecting and preventing fraudulent parties).

A goal of the present teaching may be to associate each person with a set of traits that can uniquely identify the character of the person and reflect the person's reputation online and/or in the real world. This can help peer-to-peer engagement, which refers to any type of interactions, online or in the real-world, between two or more peers for the purpose of establishing and maintaining one or more relationships, including but not limited to professional (e.g., among colleagues), social (e.g., among friends), personal (e.g. among family members or romantic partners), and transactional (e.g., among buyers and sellers) relationships. A peer in the peer-to-peer engagement refers to a natural person or an artificial human being (e.g., a robot or a software agent) that acts like a human being and possesses certain human qualities (e.g. emotion). In the present teaching, “peer,” “person,” and “user” will be used interchangeably.

The approaches in the present teaching can automatically determine a person's hybrid human traits from one's own multi-source, multi-type, context-specific data. The hybrid human traits are more reliable, and customized to a specific context.

A human trait disclosed herein refers to a person's any innate, adopted, and evolving psychological and biological characteristic or quality. Each trait is measured by a numeric score, which is called trait score or score for short. Depending on bow a trait is computationally derived, there are basic traits and composite traits. Basic traits, such as gender, cheerfulness, and extroversion, are indivisible and their scores are often directly derived from raw data (e.g., a person's digital footprints) or given by a person (e.g. a peer vote or self report). Composite traits, such as generosity and ambition, are composed by one or more basic traits and their scores are computed by combining the relevant basic trait scores. Moreover, in a computational context, each trait may be associated with one or more meta properties which are used to measure the quality of derived trait score. For example, a trait score may be associated with a reliability score to indicate how reliable the computed score is.

The approaches in the present teaching can automatically determine a person's hybrid human traits based on the analysis of short-text-based peer endorsements, which more is reliable and accurate than existing, reputation rating systems,since the text-based votes solicit more accurate input, the derived badges manifest the person's traits instead of his/her behavior, and the quality of the endorsements are assessed based on the character of the endorsers.

The approaches in the present teaching can automatically determine a person's one or more character badges from on&s hybrid human traits, which is more reliable, and customized to a specific context than any of self-reported generic profiles.

Although each person is characterized by one or more traits, not every trait helps distinguish the person from others. For example, if a person is at the average height with average friendliness,the person is hardly distinguished by his height or friendliness trait. The present teaching uses the term character badge or sometimes badge for short to refer to traits (basic or composite) that help distinguish a person and establish the person's reputation a specific context. All character badges are earned via one or more means. For example, a user of an online marketplace may earn a badge of “consistency” based on his/her behavior in the marketplace, a badge of “fairness” based on his/her digital footprints left somewhere else, and a badge of “insightfulness” based on the content of his/her reviews posted in the marketplace. Character badges may be communicated in one or more ways to externalize the badge owner's unique character and reputation to others.

Since a person's character badges are easily portable to help a person persist his/her reputation in different engagements, the approaches in the present teaching can help establish a person's reputation even in the “cold start” situation, when a new user joins the system. This is because the person is not required to exhibit any behavior in a target engagement system as long as she has tell digital footprints anywhere else or is able to import her badges from somewhere else that represents an individual, an organization, a product, or a service.

Since one's character badges reflect one's unique qualities in specific contexts and they are derived based on various evidences, they can be used to improve the effectiveness and trustworthiness of peer-to-peer engagements. For example, a person's character badges can be used to find suitable engagement partners and suggest suitable engagement methods. A person's character badges may also enable the person to obtain personalized, trustworthy content as this person may obtain content from the people with the similar badges and hybrid traits.

The character badges can also help protecting the integrity of the engagement. For example, a person's character badges can be utilized to help upholding a person's reputation, detecting and preventing fraud by measuring the consistency between one's behavior and character badges. A person's character badges may also be utilized to effectively verify and certify one's identity and reputation and protect the person's privacy (without requiring the real names). Estimating the characteristics and health of a community based on people's character badges and hybrid human traits can go beyond the traditional user-behavior based community monitoring to provide more deep insights.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

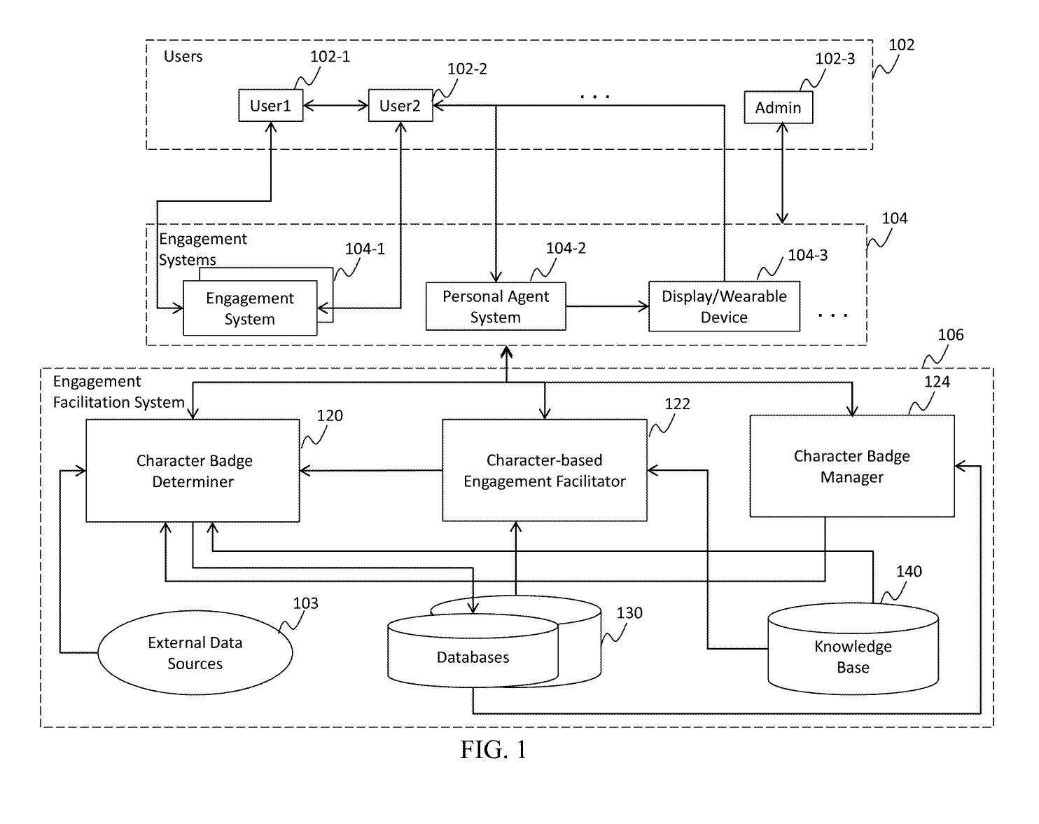

FIG. 1 is illustrates an exemplary diagram of an engagement facilitation system 106, according to an embodiment of the present teaching. Disclosed herein includes an improved process that uses one of three key functional modules alone or in combination to augment a peer-to-peer engagement process. As a result it improves the peer engagement quality from one or more aspects, such as engagement transparency (knowing more about your engagement parties), trustworthiness (knowing whom to trust by their character), effectiveness (knowing how to best engage with someone by their character), and integrity (knowing how to identify fraudulent situations by people's character or the changes in their character).

FIG. 1 displays one of many embodiments of the engagement facilitation system 106 for implementing the disclosed improved process with the use of one or more of the three functional units to augment and improve one or more peer-to-peer engagement systems. The three functional units are: (a) character badge determiner 120, (b) badge-based engagement facilitator 122, and (c) character badge manager 124. Typically, an engagement system 104-1 engages with two or more users 102-1, 102-2. Such an engagement system may be an online social networking system, such as Facebook, Twitter, and LinkedIn, or an online marketplace such as Airbnb, Liber, and Ebay. Another type of engagement system may be a content provider, such as Yelp, TripAdvisor Reddit or Medium, where readers engage with one another via reviews and commenting. There are two main types of engagement, online or in person. In each case, there are many exemplary utilities of the invention to improve a peer-to-peer engagement process.

For any online engagement, one exemplary use of the present teaching is for a user to obtain his or her character badges. A user may first log on to an engagement system 104-1. The Character Badge Determiner 120 is then called to automatically analyze the user's data stored in the external data sources 103 and uses the knowledge base 140 to infer the user's human traits and create one or more character badges from the inferred traits. The created badges along with other related information are then stored in the databases 130. The created badges may also be used to update/augment the representation of the user (e.g., a profile) in the engagement system 104-1.

Another exemplary use of the present teaching in an online engagement is for a user to obtain more information about existing or further engagement parties. In this use case, the engagement facilitator 124 is called to provide suitable engagement information, partners, and methods based on a person's character badges and that of others in the system stored in the databases 130. A user may explicitly request such information. For example, a user may request the character badge information of a stranger to be engage& Based on the information sharing and privacy policies, the facilitator may tenant all or partial requested information to the user. The facilitator may also generate recommendations automatically based on a system default setting, the setting by a user, or a setting made by a system administrator. For example, the facilitator may automatically recommend the right people to be engaged or matched engagement instructions. The facilitator uses the knowledge base when making its recommendations.

Another exemplary use of the present teaching is to manage the generated character badges to ensure their freshness and integrity. As a user generates more data (e.g., writing a review) and engages with others, his/her character badges may need to be updated. The character badge tanager 124 is to help update a user's one or more character badges either periodically or on demand. While a user may request such an update on higher badges explicitly, in most cases a system administrator 104-3 sets up an update schedule to ensure all users' character badges are up to date. In other words, a system administrator sets up a periodical update task with the character badge manager 124 which can call the badge determiner 120 periodically to update the badges of all users.

Another exemplary utility of the present teaching is to manage the integrity of the online engagement system based on users' character badges or the changes in them. In such a situation, an administrator may call the character badge manager 124 to monitor the irregular user activities and even fraudulent events (e.g., account hijacking) based on the change patterns in users' character badges. The manager may also automatically alert a administrator of the abnormalities and suggest corrective actions suspending a particular use

Yet another exemplary utility of the present teaching is to support the export/import of a user's one or more character badges. A person is often associated with one or more engagement systems (e.g., Facebook, Twitter, and Airbnb), she or he may want to export/import one or more her/his character badges from one engagement system (e.g., Facebook) to another (e.g., Twitter). Thus, one may be able to show more comprehensive picture of himself/herself in any system. For example, a person is quite active on Airbnb as a room host and has earned one or more character badges, but she is new on Etsy as a seller. To help establish her reputation as an Etsy seller, she may import one or more of her Airbnb character badges that matter to being a seller (e.g., the badge of being “responsible”) to her Etsy seller profile. The badge manager 124 supports such export/import of one or more character badges including conflict resolution if there is any.

In addition to online engagement, another exemplary use of our present teaching is the support of in-person engagements. One exemplary utility is where a user calls a personal agent system 104-2, which may he installed on the user's cell phone, to obtain his/her own character badges through the badge determiner 120. The badges may be displayed through various displays 104-3, such as a projected display and a wearable electronic badge, to display one or more of their character badges and facilitate their in-person with others. Depending on the context, a user may choose to “advertise” one or more character badges to attract potential parties. For example, a conference attendee may update her electronic badge to publicize her interests and personality to attract other attendees alike. A college student may “advertise” his character by projecting his related badges onto the rear window of his car to attract and bond with like-minded classmates.

Similar to an online engagement, another utility of our present teaching for in-person engagement is for a user to obtain engagement “engagement intelligence”, such as learning about the character of a stranger to be engaged in person and/or how to engage with the stranger. In this case, the user calls the personal agent system 104-3 to request advices from the engagement facilitator 122 and the badge determiner 120 to derive one or more character badges of the stranger and recommend engagement advices.

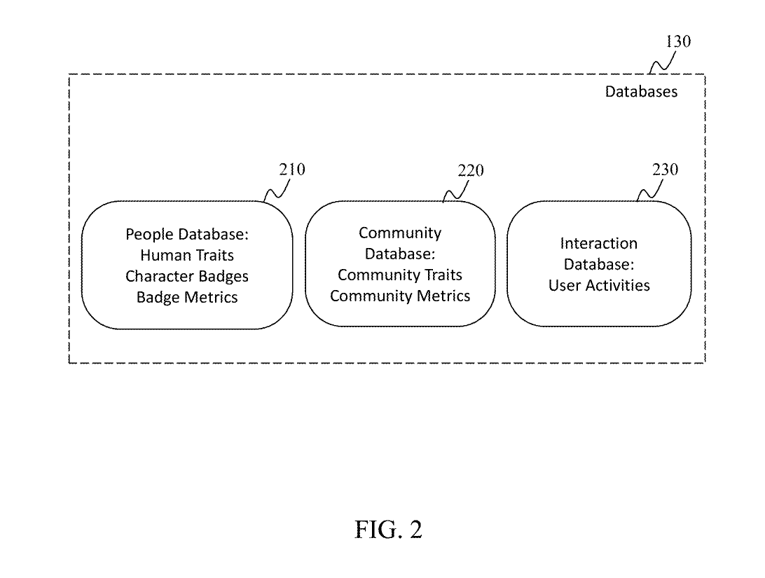

FIG. 2 illustrates content in databases for characterizing a user's reputation, according to an embodiment of the present teaching. FIG. 2 shows information stored in the databases 130. It may include a people database 210 that contains information about each user of an engagement system such as his/her human traits, one or more character badges, as well as the metrics used to gauge the change patterns in one or more badges. It may also include a community database 220, which captures the relationships (latent or explicit) among users, the summarized traits of a community, and metrics used to measure the properties including qualities of a community. It may also include an interaction database that records all user activities including interactions with one another.

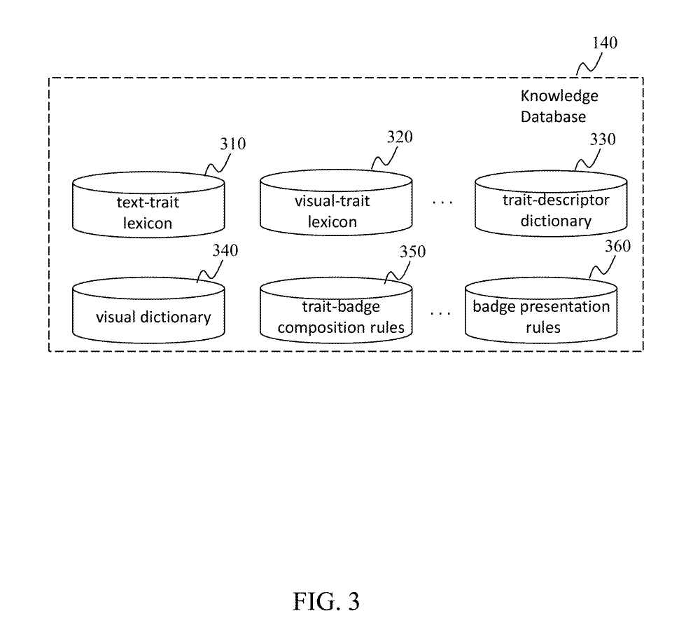

FIG. 3 illustrates content in a knowledge database, according to an embodiment of the present teaching. FIG. 3 shows the elements in the knowledge base 140. The use of these elements (e.g., text-trait lexicon 310) will be described in context below.

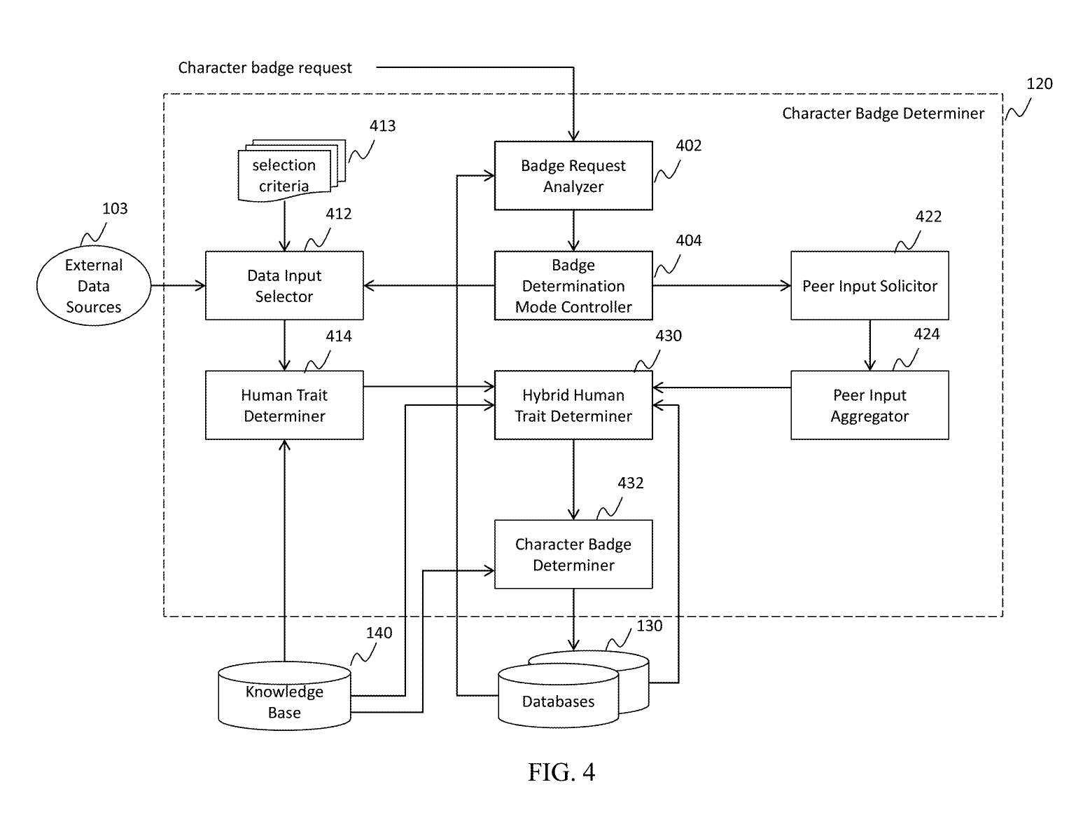

FIG. 4 illustrates an exemplary diagram of a Character Badge Determiner 120, according to an embodiment of the present teaching. The character badge determiner 120 aims at deriving a person's one or more character badges from various data sources. Overall, it may have three key functions: (a) human trait determination, (b) badge determination, and (c) badge generation.

FIG. 4 illustrates one of many structural embodiments for constructing a character badge determiner with one or more key components. As shown in FIG. 4, given a character badge request, the request analyzer processes the request 402. During this analysis, it checks the databases 130 to tell whether such a request is to determine one or more character badges for a new user or an existing user who is already in the databases. It also checks to see what kind of data sources be used for determining the badges. Based the analysis results, the request analyzer formulates a badge determination task, which is sent to the controller to be achieved 404.

Depending on which data sources are used, the controller 404 calls the corresponding component to automatically infer one or more human traits for a person. Broadly, there are two types of data sources that may be used to determine a person's traits: one's own behavioral data and peer input. Here one's own behavioral data includes but not limited to one's write-ups, likes, and sharing activities. On the other hand, peer input is one or more peers' endorsement on one or more characteristics of a person.

Although there are a number of existing approaches that automatically determine human basic traits like Big 5 personality traits from a person's own behavioral data, none of the approaches handle the determination of traits from different types of data residing in multiple data sources, let alone the derivation of composite traits. Moreover, in this process it also accounts for the underlying engagement context when choosing data sources and/or consolidating trait results. This trait determination model automatically derives one's both basic and composite traits from one or more data types/sources, and measures the confidence associated with the trait computation, in a particular context. In such a case, module 412 is first called to determine the data sources to be used based on one or more criteria 413, such as data availability, data quality, and context relevance, since a person's behavior may be captured in one or more data sources. Once the data sources are selected, the trait determiner 414 automatically infers a set of human traits. If multiple data sources are used, the trait determiner also consolidates the traits derived from data sources.

In addition to determining one's traits from one's own behavior, alternatively, one's traits may be determined based on peer input. This step includes two key sub-steps; peer input solicitation and peer input aggregation. Unlike existing peer endorsement (e.g., LinkedIn) or vouching methods, which normally asks a peer to select from a pre-defined list of endorsement items e.g., Linked in skill items and the trait items) that an endorser may or may not understand, this present teaching reveals a more flexible and effective tag-based approach that gather peer input in context. Moreover, when aggregating peer input together, it also takes into account a number of factors including the character of the endorser that has been rarely considered to make the results more accurate. Given a person/user, module 422 is first call to solicit a peer's input on one or more traits of this person. This module also translates often free-formed user input into system-recognizable human traits. However, human endorsements may not always produce consistent or even meaningful results. For example, one may receive multiple endorsements on one trait from the same peer but with different scores, or from multiple endorsers with different scores. On the other hand, a person may receive just a single endorsement on a trait. Thus, module 424 is called to consolidate redundant, inconsistent endorsements and discard insignificant ones.

No matter which data sources are used to derive a person's human traits, all derived traits are then sent to the hybrid trait determiner 430 to produce a set of combined human traits. In the case where the task is to update an existing user's badges, the trait determiner also consolidates the traits derived from new/updated data sources with that already stored in the databases. Moreover, it may trigger the update of composite traits if one or more of its lower-level traits have been updated due to new or updated data (e.g., new behavioral data or peer input).

The full update, integrated traits are then sent to the badge determiner to derive one or more character badges 431 The derived badges are stored in the databases 130. In this configuration, several components, including modules 414, 430, and 432 may Use the knowledge base 140 to make respective inferences.

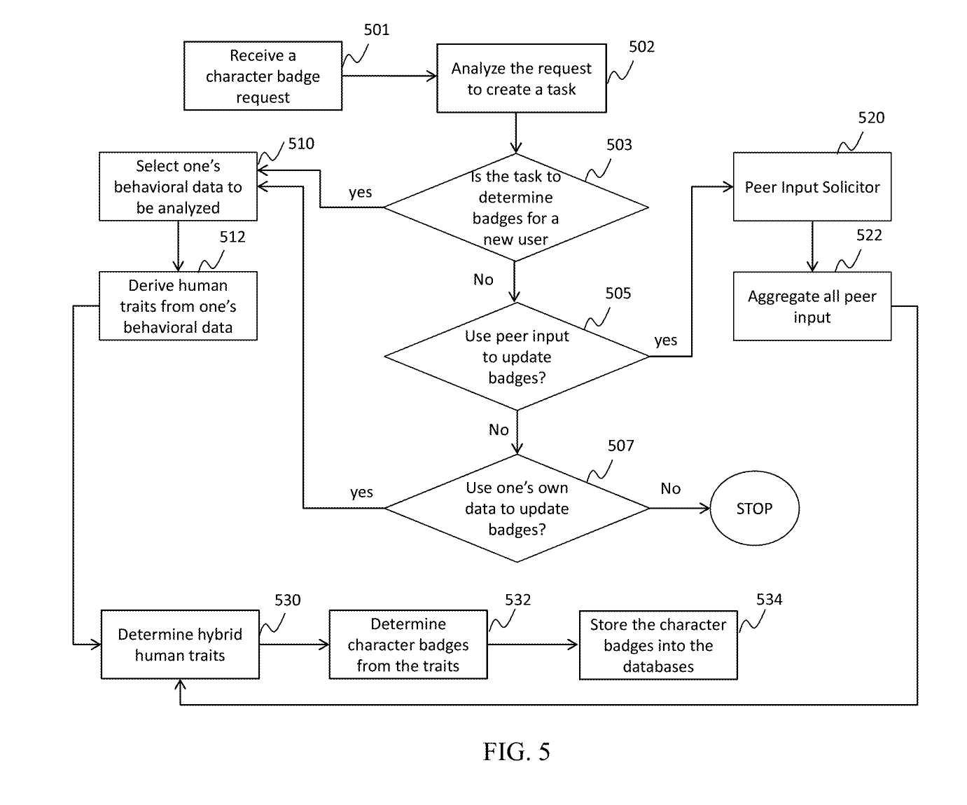

FIG. 5 shows a flowchart of an exemplary process performed by a Character Badge Determiner, according to an embodiment of the present teaching. As shown in FIG. 5, the process flow of determining a target person's character badges starts with a character badge request received at 501. Such a request is first analyzed at 502 and a badge determination task is created. If the task is to determine at 503 one or more character badges for a new person who is not in the databases, module 510 may be first called to select the person's behavioral data 510.

Since a person's behavior may be captured in one or more data sources, the step 510 is to determine the data sources to be used based on one or more criteria, such as data availability, data quality, and context relevance 511. A simplest approach is by data availability: using whatever available data sources provided by a user. If two or more data sources are provided (e.g., Facebook and Twitter), the data from these sources may be simply combined for analysis. To ensure the integrity and quality of operations, most preferably, this step should select only suitable data Sources to use. First, different engagements require different data. Assuming that the underlying peer-to-peer engagement system in FIG. 1 is an online marketplace for job seekers, LinkedIn and Twitter may be more desired data sources as they often reflect people's professional life. In contrast, if the marketplace is for trading fashion, Facebook, Instagram, or Pinterest may be more suitable sources. Moreover, data quality may vary in different sources, which directly impacts the quality of character badges created later and the integrity of engagements. Data quality may be determined by one or more criteria, such as density (how much behavior is captured), distribution (all the behavior occurs at once or distributed over a long period of time), and diversity (how diverse the captured behavior is). Since it is easier for someone to fake low quality data (e.g., faking behavior at one shot vs, over an extended period of time), this criterion may also help detect and prevent the creation of fraudulent badges.

By the data selection criteria, one of many methods or in their combination may be used to determine the data sources. One exemplary method is to first let a user interactively specify one or more data sources, which provides the user with certain freedom to decide which aspects of his/her life to be analyzed and exposed. The system then evaluates the user-volunteered data sources and decides which ones to use by the selection criteria. Another exemplary method is to let a system selects one or more qualified data sources by a set of criteria, and then prompts a user to provide the data (e.g., via Facebook login). In this approach, all possible data sources are stored in a knowledge base and associated with a set of descriptors, e.g., <Facebook, personal, 0.8>, <LinkedIn, professional, 0.5>. This means that Facebook may be a good data source to use if it will be used to characterize one's personal aspects and the quality of one's Facebook exceeds 0.8; otherwise. LinkedIn may be a better one if for professional purpose and the estimated data quality exceeds 0.5.

After determining what data to use, the next step is to derive one's human traits from the data at 512. Depending on the type of data (e.g., likes vs. write-ups), different trait engines may be used. One exemplary trait engine is to use a lexicon-based approach to analyze textual data and derive human traits. Associated with such an engine, a text-trait lexicon is first constructed to indicate the weighted relationship between a word, such as “deck”, and a particular trait, e.g., conscientiousness, with a weight, say 0.18. Such a text-trait lexicon may be constructed based on studies in Psycholinguistics that show the relationships between words and human traits. The trait engine then takes a person's textual footprints (e.g., reviews, blogs, and emails) and counts the frequencies of each word appearing in the trait lexicon. The counts are often normalized to handle text input with different lengths. For each trait t, it then computes an overall score S by taking into account all M words that have relationships with t in the lexicon:

S(t)=C(word₁*wⱼ+C(word₂*w₂C(word_{M})*w_{M} (1)

Here C(wordᵢ) is the normalized count of wordᵢ in the input and wᵢ is its weight associated with trait 1.

Another exemplary trait engine is a rule-based trait composite engine that takes one or more basic traits to out one or more composite traits. Associated with such a trait engine is a set of trait composition rules or formula, where each rule specifies the following:

S(ct)=S(tₗ*wₜ+ . . . S(tₖ)*w_{K} (2)

Here S( ) is a score, ct is a composite trait, consisting of K basic traits, tₗ, . . . t_{K}; and wⱼ, . . . w_{K} are the weights, respectively. The score of a basic trait may be computed by a trait engine described above (Equation (1)), and the corresponding weight may be determined empirically For example, composite trait diligence is related to basic traits, self-discipline (positive), achievement striving (positive), and agreeableness (negative). In this case, one may assign equal weights 1, 1, and −1 for the three basic trait components.

Such composition and weights may also be trained automatically. Specifically, we first construct a set of positive and negative examples based on ground truth. Each positive example represents a diligent person characterized by his/her derived basic trait scores and a label indicating his/her diligence (e.g., diligence=1) On the opposite, a negative example represents a not-so-diligent person Characterized by his/her derived basic trait scores and a label indicating a lack of diligence (e.g., diligence=0.) These examples are then used to train a statistical model and infer the weights (contributions) of various basic traits to this composite trait. The inferred weighs then may be used to compute the score of a composite trait.

Just like any other data analysis engines, the quality of the data or the analytic algorithms themselves is hardly perfect. To assess the quality of a derived trait score, quality metrics are also computed. There may he two most important quality metrics in deriving a human trait score: reliability and validity. Reliability measures how consistent or stable the derived results are, while validity evaluates the correctness or accuracy of the derived results. There are many ways to compute the reliability. One exemplary implementation of computing reliability is to use each person's different sample data sets (e.g.,, random samples of one's all Facebook status updates) to derive the traits and examine how stable the results are. Although there are many methods for measuring validity, validating the correctness of the results takes time. For example, assessing whether a person is actually responsible, real-world evidence is needed. In a specific engagement context, one method is to log a user's behavior e.g., always finishes a task on time) that may be used as a positive or negative evidence to validate one or more traits (e.g. responsible). Over time, a validity score may be computed based on the prediction power of a trait on the corresponding behavior.

As described above, one or more data sources may be used in deriving one's human traits. Moreover, one or more types of data may exist in a single data source, each of which is used to derive a set of traits. For example, one's Facebook data source may include three types of data: likes, status updates, and profile. This step 512 thus also consolidates derived traits together based on one or more criteria, such as data type, data source, trait type, and trait quality.

One exemplary implementation is to consolidate the Farne type of traits derived from different types of data (e.g., Facehook likes and status updates) in a single data source (e.g., Facebook) by taking the mean or average of the trait scores if the scores are similar enough. However, if the differences among the scores are too great (e.g., exceeding 3× standard deviation), the confidence score associated with each trait may be used to determine which ones to keep since such confidence score measures the quality of a computed trait score. Another exemplary method is to preserve trait scores by data sources. Suppose that a set of traits <is derived from Facebook, while another set <t′₁, . . . t′_{K}> is derived from Twitter. The consolidation keeps the dominate traits (max or min scores) derived from Facebook data if the traits characterize one's personal side (e,g,, social and emotional characteristics), while keeping the dominate traits derived from Twitter if the traits describe one's professional aspect (e.g., hardworking and ambitious). The trait type may be determined in advance and stored in the knowledge base to indicate what life aspects a trait describes, and a trait (e.g., conscientiousness) may describe multiple aspects of one's life. In such a case, trait scores derived from different data sources may be preserved unless the data sources are considered similar Pinterest and Instagram). This is because a trait may be context-sensitive (e,g, a person may be high in conscientiousness in one's professional life but much less so in the personal life) so we want to preserve the different scores to reflect this person's different character in different contexts.

After the consolidation, if a person is still associated with two or more sets of derived traits, this step then designates one set as the primary trait set based on the specific engagement context. For example, if the underlying engagement system is an online fashion commerce site, one's primary trait set is most likely the one derived from Facebook, while the primary trait set is most likely derived from LinkedIn for an online job marketplace.

The determined human traits are then sent to an aggregator for further process at 530. In the current flow, since the target person is new, the aggregator does nothing but sends the derived traits to 532, where one or more character badges are determined as described below.

If the formulated badge determination task is not for a new person at 503, it then checks whether it is to use peer input to update one or more badges of an existing person at 505. If it is true, it then goes to 502 to solicit the peer input for the target person.

Given a person/user, this step 520 solicits a peer's input on one or more traits of this person Instead of pre-defining a long list of traits and then asking a peer to vote on, a more flexible and effective approach is to let a peer input text tags to describe one's traits in context. One exemplary implementation is to prompt person A to tag person B when A is reading B's comments. To further aid peer input, frequently used, user-generated tags may be suggested when a peer is entering his/her own tags. Another exemplary implementation is to prompt person A with a question, such as “name the top 3 most diligent people you know”. As a result, the three people will be tagged with “diligent”. In addition to entering a tag, a more preferable approach is to let one also enter a score with the tag to indicate the strength of the underlying trait, e.g., <diligent, 0.5>.

Since a tag is basically one or two keywords given by a person to describe a trait, it needs to be associated with the underlying trait. To associate a tag with a trait, in most cases the process is straightforward, since a tag may be directly associated with a human trait by looking up in a trait-text lexicon in the knowledge base. This lexicon associates each trait with one or more word descriptors. In case where a direct mapping does not exist, the tag may be expanded into a set of tags to include its synonyms. The lookup is then performed again to find an association. In the worst case, a human (e.g., a user or a system admin) may be involved to manually associate a tag with a trait.

At 522, the output of the last step 520 is one or more traits along with their scores (if scores are not specified by an endorser, by default it is 1 given by one or more endorsers to a person: { . . . , <tᵢ, sᵢ, eⱼ>, . . . }, where tᵢ is an endorsed trait, sᵢ is trait score, and eⱼ is the endorser.

While methods such as a simple voting method may be used, i.e., choosing the trait and its score that have been endorsed the most of times, another method is to assess the weight of each endorsement based on one or more factors, such as the endorser's relationship with the person or the endorser's activeness. However, one factor that is rarely used is the character of the endorsers themselves, since existing systems are not able to obtain such information. Since the method described in 512 is able to extract one's human traits including an endorser's traits, one exemplary implementation in to use the character of an endorser for weight determination. This implementation assigns a higher weight to an endorsed trait if the trait belongs to a specific trait type and the endorser him/herself also scores high on the same trait. Here each trait is associated with a trait type in our trait lexicon 140. For example, there are traits, such as trait Fairness, belonging to a type that we call liable traits and indicating how responsible a person is, which in turn renders one's endorsement more reliable and trustworthy, in another example, there are traits like trait Methodical, belonging to another type we call big-ticket traits, which indicate that these traits are hard to “earn”. If someone who already possesses hard-to-earn traits like. Methodical endorses others on the similar traits, it makes such an endorsement harder to earn and more trustworthy.

Once the weight of each endorsed trait is determined, one or more methods may be used to consolidate redundant and/or inconsistent endorsements. One exemplary consolidation is to use a weighted linear combination, while another is to choose the one with the biggest weight. The weights may also be used to determine whether an endorsement is insignificant and should be discarded at the current time (e.g., the weigh is below a threshold). This is especially useful for judging a trait that has received only one or two endorsements, where the endorsers' character may largely determine the significance of their endorsements.

The aggregated peer input is then sent to the trait aggregator for further processing at 530. According to one embodiment, at this point, the process checks whether the task also requires the use of one's own data to update the existing badges at 507. If it is yes, it calls the sub-process of determining human traits from one's behavioral data as described above at 510 and 512. Otherwise, the process moves forward to call to determine one or more badges from the derived human traits at 532. Note that even if the badge update task does not require the use of peer input at 505, it still checks if the task requires the use of one's own data to update the badges for an existing person 507. If it does, the sub-process of determining human traits from one's own data at 510 and 512. Otherwise, it stops.

This step 530 is to integrate the two or more sets of derived human traits. For example, step 512 may derive one set of human traits from one's own data, while step 522 may produce one or more human traits from peer input. Moreover, when a task is to update a target person's character badges, the derived traits need to be integrated with those already stored in the databases. To integrate two or more sets of traits, the approaches in the present teaching described below first merges two sets of traits. The approach may be repeated as needed to merge all the trait sets.

Although there are many simple implementations to integrate two trait sets together, a more preferable approach is to use the quality of derived traits to guide the integration and resolve conflicts. One such exemplary implementation starts with the set that has a smaller number of traits derived and integrates each trait in this set into the bigger set. When integrating trait t, in the smaller set into the bigger set, there are two situations: (i) if there is no corresponding trait t_{b} in the bigger set add tₛ into the bigger set; (ii) otherwise, integrate tₛ and f_{b}. In their integration, if these two traits have similar scores (e.g., within a threshold), an average of the two may be used. On the other hand, if the disparity between the two trait scores is too big (e.g., exceeding 3× standard deviation), it then checks the confidence score associated with each trait score. For data-derived traits, the confidence score may be its reliability score or validity score (if exists) as explained in 512, while for peer-endorsed traits, the confidence score is their computed weight as explained in 522. If only one of the confidence wore exceeds a threshold, its related trait score is then kept. However, if both confidence scores are either below or above the threshold, both trait scores are kept but with a conflicting flag attached. A conflict flag will not be taken down until the conflicts are resolved, e.g., trait scores or their associated confidence scores are changed in the future due to new input, such as new peer endorsements.

Since composite traits are made up of one or more basic traits. If the integration such as the described above has updated one or more basic trait scores, then the corresponding composite trait scores are also updated. For example, initially a person's trait self-discipline derived from his own data (or perhaps due to a lack of data) is low. However, via peer endorsements, the person obtained a high self-discipline score, which also comes with a high confidence (weight). During the integration, the high score will be used. Any composite traits, such as lowness, which are used for the previous lower score, are also updated accordingly.

As defined earlier, a character badge indicates a particular characteristic or quality of a person that distinguishes him/her from others in a particular context. This step 532 thus is to determine a person's one or more character badges from his/her derived human traits in a specific context. One exemplary implementation is to determine a badge based on one or more derived human traits. This method first computes a total qualifying score Q( ) for a person (p) to obtain a badge (b) in context c. The following is an example formula that may be used to compute such a score:

$$Q ( p , b , c ) = {\sum }_{i = 1}^{K} Distinctiveness ( S ( {t}_{i} ) , c , threshold ) + Quality ( S ( {t}_{i} ) ) + …$$

Here we assume that different contexts award different badges. For example, an online review system such as Yelp or TripAdvisor may give out badges, such as Fairness and Insightfulness, while a social networking system like Facebook or LinkedIn, may award badges, such as Responsiveness. Furthermore, each badge b may be measured by one or more specific human traits. For example, the Insightfulness badge may be measured by traits such as Analytical and Intellect.

According to the above formula, qualifying a person p for a particular badge b is to examine person p's all K traits related to badge b by one or more criteria. For example, it examines the Distinctiveness( ) of a trait against a threshold (e.g., one must score top 15% on this trait) in context c. Since one's reputation is often context sensitive, the distinctiveness is relevant against a particular population in the specific context. For example, in an online trading system, one's Responsiveness is just the average comparing to that of his peers, although such a score may be much higher than that of the average population. Thus, in the trading system context, the person may not qualify for the Responsiveness badge. Since trait scores may be derived from different data sources with different methods, the quality of the scores may also affect the badge qualification. Thus, the Quality( ) criterion examines the confidence factor or probability associated with the derived score. All metrics may be normalized for computational purpose. If the computed overall qualifying score exceeds a certain standard, e.g., an absolute threshold or a relative threshold (ranked in the top 10%), a badge is then awarded.

If a badge is awarded, we then compute its strength, which indicates how strong the obtained badge is. This information is useful in aiding fine-grained comparison among people. For example, if two or more people have received the same badge, they can still be distinguished by their respective badge strength. Below is an exemplary formula that computes the strength of a badge (b) based on it relevant K trait scores:

$$Strength ( b ) = {\sum }_{i = 1}^{K} S ( {t}_{i} ) \times {w}_{i}$$

Here S( ) is the score of trait tᵢ and wᵢ is the corresponding weight, which indicates the contribution of tᵢ to this badge. The weight may be determined empirically based on human experience in a particular context or automatically learned through supervised machine learning. In such a learning process, a set of examples (training data) is first constructed. Each example encodes a set of trait scores and the related badge. These evidences are then used to train a statistical model, which derives the weights for respective traits to show how much they have contributed to a particular badge.

In addition to badge strength, another important information related with a badge, it its status. Since a person may change or the context may change (e.g., badge qualifying criteria), a badge may be expired due to certain changes. For example, after a reviewer is awarded an Insightful badge, the quality of his reviews has degraded. In such a situation, his badge may expire after a certain period of time. Thus, during its lifecycle, it may be in one of such status: active, expired, and suspended (due to certain violations or fraud).

Depending on the system set up, the desired types of badges and the traits associated with each badge may be pre-defined and stored in the knowledge base 140. Alternatively, the badge types and/or associated traits may be solicited from users of the system. Yet another alternatives to let a system seed a few badges and then let users of the system to come up with new badges. Using the above formula, a qualifying scare may be computed for a given person for each badge defined in an engagement system. Depending on the qualifying score zero or more character badges may be awarded to the person.

As a result, an earned character badge is associated with at least one or more pieces of information. The badge name/type; The badge strength; The badge status; One or ore other badge properties, such as qualifying score, qualifying time, qualifying context, and expiration and The associated trait scores and their properties e.g., confidence factor and data source).

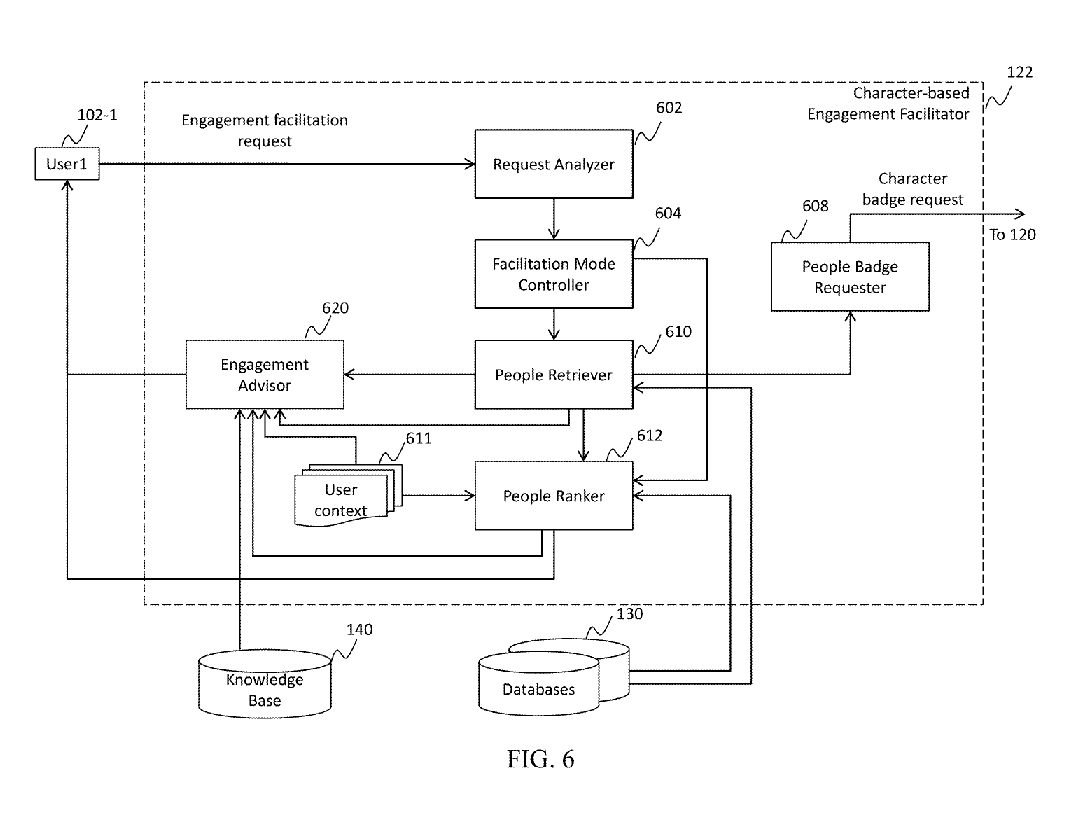

FIG. 6 illustrates an exemplary diagram of a Character-based Engagement Facilitator 122, according to an embodiment of the present teaching. The goal of the engagement facilitator 122 is to provide a user with various engagement advices, such as whom and how to best engage based on the character of parties involved. Such engagement advices are often context sensitive to ensure the most effective engagement. For example, the advices given for a user to engage with a potential romantic partner at an online dating site may be quite different from the instructions given for a user to engage a seller or buyer in an online marketplace such as Etsy or Airbnb. A user may obtain engagement advices in one or many ways based on her/his context.

FIG. 6 captures ways for a user to obtain engagement advices, although by no means the exemplary structural configuration of the facilitator has exhausted all configuration variants, which may achieve the same or similar effects of facilitating a peer-to-peer engagement based on the character badges and/or human traits of involved parties.

The input to the facilitator 122 is an engagement facilitation request. Such a request may be explicitly submitted by a user or automatically generated by a system. For example, an online dating system may periodically generate such a request to discover suitable engagement partners (dates) and instructions for all or some of its users. Given such a request, the request analyzer 602 processes the request to generate a corresponding facilitation task, which is dispatched by a controller 604 to drive different components to work together to complete the task.

One exemplary task is to facilitate the engagement with a particular target specified by a user. In such a ease, the user may specify an id of the target (e,g., a Twitter screen name or a Facebook Id). Given such an id, the people retriever 610 ties to locate the person related to this id in the databases. If such a person does not exist, a request may be generated and forwarded to the badge determiner 120 to Create an entry for this person in the people database by deriving the human traits and character badges for the target. If this is the case, a user may even decide to submit relevant, accessible data sources (e.g., the previous exchanged communication content between the target and the user) for the trait and badge determination. In the case where the target is found in the database, the target's character badges along with relevant traits are retrieved. The information is then sent to the engagement advisor 620. The engagement advisor also calls the retriever 610 to retrieve the traits and character badges for the user. Using the traits of the user and the traits of the target, the engagement advisor outputs one or more engagement advices.

Another exemplary task is to facilitate the engagement with one or more known targets. In this case, the user is aware of a group of potential targets but wants to find out who or whose message is most relevant to his situation. Assume that a user is browsing a set of hotel reviews on TripAdvisor and wants to sort the reviews in a way that is most relevant to him, such as by reviewers who are most similar to him or by reviewers' reputation (e.g., insightfulness and trustworthiness). To accomplish this task, the controller calls the people ranker 612 to rank the target group of people based on one or more pieces of information, including the user's own character badges and traits as well as a user's context 611. Here the user's context may include different types of user preferences, such as target preferences (i.e., whom/what to engage with) or ranking preferences (i.e., whom/what to see first). For example, in an online dating context, the user's target preference may be to find someone with a compatible personality, while in the context of Airbnb the target preference may be to find a meticulous host or a careful driver in the context of Uber. Such preferences may be entered by a user explicitly or set as the system default (e,g., online marketplaces like Airbnb and Uber may set up such target preferences for each of their users by default). Since the ranking preferences indicate what/whom a user prefers to see first, the targets may be ranked in different ways, e.g., ranking targets by their derived traits with highest scores and confidence vs. by their derived traits that best match with that of users. The ranking results may be sent to the user directly or sent to the engagement advisor 620 for further suggestions. For example, the advisor may suggest follow-on engagements with additional questions. The details on how recommendations may be made are given below as part of the process flow.

It is worth pointing out that although the applications of the engagement facilitator might vary greatly, the core technology is the same. For example, in a system like Yelp and TripAdvisor, the application may be to find relevant information (reviews) for a user instead helping the user to engage with the reviewers per se. In contrast, in a system like Facebook or LinkedIn, the application may be to help a user find the right people to engage with. Moreover, in a system like Airbnb, and Uber, the application may be to do both finding the relevant reviews as well as relevant hosts/renters to engage with. No matter which application is, the underlying core technology is still to help users accomplish their tasks by assessing relevant people's reputation and traits.

Another exemplary task is to facilitate the engagement with one or more unknown targets. In this case, the user does not know whom to engage with and how to best engage with them. For example, in an online dating site or a marketplace like Airbnb, a user may want to find a date or a host by certain criteria and also learn how to engage with them. This task is similar to the task described above except that the people retriever is called first to retrieve one or more people based on one or more search criteria. A user may specify the search criteria explicitly. For example, one user may specify to find people who are similar to him/her or to find people with certain character badges (e.g., Honesty and Responsive). The retrieved results are then sent to the people ranker to be ranked based on the context as described above. Note that this task including the search criteria may come from a system instead of a user so that the people retriever 610, people ranker 612, and engagement advisor 620 are triggered automatically (e.g., by a timer) and a user receives system recommendations periodically.

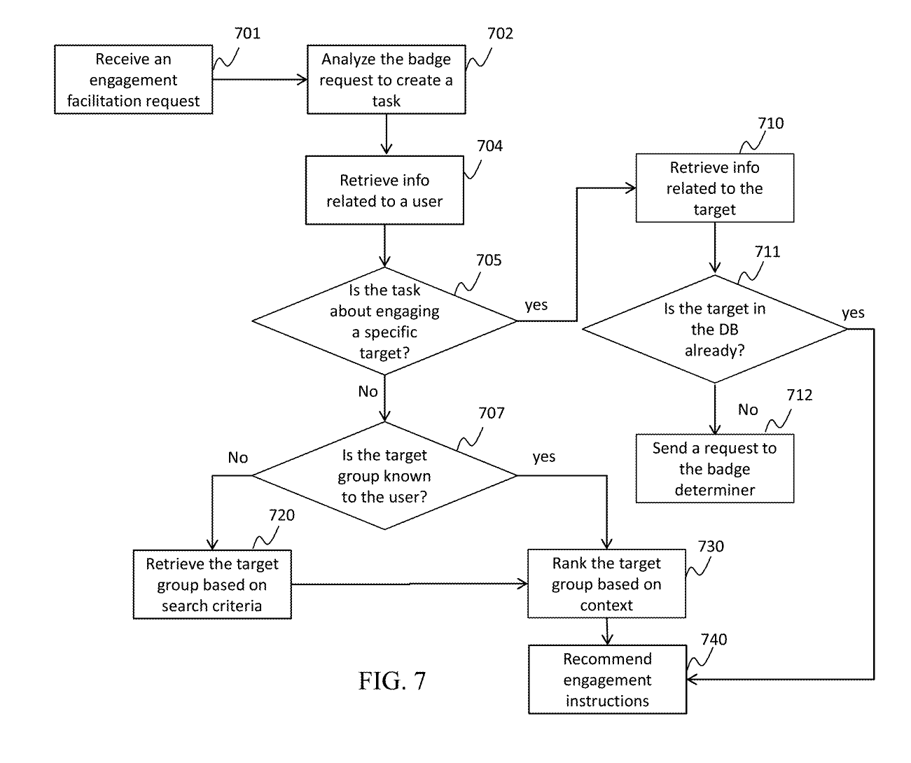

FIG. 7 is a flowchart of an exemplary process performed by a Character-based Engagement Facilitator, according to an embodiment of the present teaching. FIG. 7 captures different process flows for processing different types of engagement facilitation request. Given an engagement facilitation request received at 701, it is analyzed to create a corresponding engagement task at 702. Next is to retrieve all the relevant information about the user who either issues the request or is someone that the system aims at helping at 704. The process then tests whether the task is about engaging a specific target person. If it is, it then retrieves the relevant information about the target person from the databases at 710. If such a person does not exist, a request is then generated and sent to the badge determiner for creating an entry for the target person at 712. If the person does exist, the information about the person is then used to make proper engagement advices at 740. One the other hand, if the task is not about a specific target person at 705, it tests whether the task is about a known group of people at 707. If it is, this group of people is then ranked based on one or more criteria at 730. The ranked list is then sent to the engagement advisor for engagement advices at 740. However, if the target group is unknown at 707, the next is to retrieve one or more targets based on one or more search criteria at 720. The search results are then sent to be ranked at 730 and then processed by the advisor at 740. Next we describe some of the exemplary implementations of at steps 720, 730, and 740.

People retrieval at 720 is based on OM or more people search criteria. The search criteria may be specified by a user explicitly through one or more user interfaces, such as through a button “people are like me” or selecting menu items that indicate people with one or more character badges. The search criteria may also be generated by a system automatically in the process of making people recommendations to a user. For example, in an online dating system, the system may generate a search criterion to retrieve “personality compatible people” for any user. Note that here all the search criteria are about finding people based on one or more of their traits or their character badges. Given the search criteria, the retrieval process is similar to any database retrieval, it first finds people who match all the search criteria. In case there are no people who match all the criteria, the retriever may retrieve people who match part of the criteria. The retrieval results indicate whether an item is a full or partial match.

The retrieved people are ranked at 730 based on a user's or system preferences. One approach is to compute a rank for each retrieved person based on one or more preferences. One such preference is the similarity between the retrieved person and the user under help. The similarity is calculated based on their character badges and/or human traits. The more similar the person is to the user, the rank of the person is higher. Another preference is based on the character badges associated with a retrieved person and the properties of the badges, such as the qualifying score. The more badges the retrieved poison has earned and the higher the qualifying score is, the rank of the person is higher. Additional criteria may also be used in the ranking, such as the past interaction or relationship between the retrieved person and the user. A user may also specify a particular ranking criterion, e.g., ranking people by a particular badge type. Note that the rank of the people may also be used to rank the content generated by the people. For example, a user wants to read a list of hotel reviews by the order of the authors' brightfulness. In such a case, the reviews are then ranked by the authors whether they have earned an insightful badge, and the properties of the badge, such as its qualifying score.

The advisor makes various engagement advices for a user. One type of advice is on how to engage a specific target person. As described above, it takes the information about the user and the target person, and then suggests engagement instructions. As in human-human interaction, there are many types of engagement instructions. One type is how to introduce oneself. Like attracts like. One instruction is to highlight the character similarities between the user and the target person. This includes the highlight of shared traits or character badges. Another type of instruction is on the use of particular words/phrases that resonate the most with the target person. The word choices may be determined by the character badges of the target person. As described earlier in 512, words may be used to derive human traits, which are then used to derive character badges of a person. So the system knows that the words used and could include such words in the instruction for consideration in composing communication messages. If a target is unknown, the advisor may also recommend a right target to engage. In such a case, the advisor choose top-N ranked targets produced at 730, and suggests a set of engagement instructions for each candidate as described above.

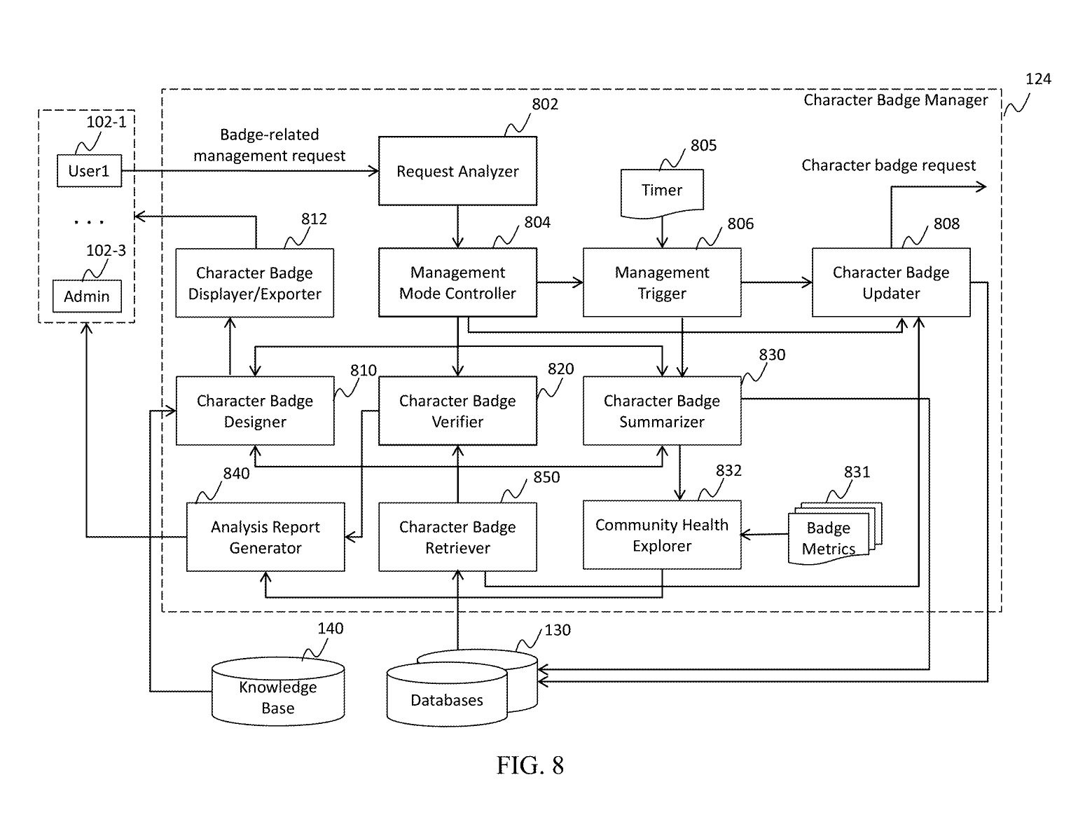

FIG. 8 illustrates an exemplary diagram of a Character Badge Manager 124, according to an embodiment of the present teaching. For different purposes, a human user may issue one or more management request in a peer-to-peer engagement system that is augmented with character badges of people. Here a human user may be one or more persons who performs different roles on a peer-to-peer engagement system, such as a user, a system administrator, an engagement facilitator such as a community manager. A character badge-based manager 124 may be configured with one or more key components to handle one or more management requests.

FIG. 8 captures one of many structural configuration of a character badge-based manager. As shown in FIG. 8, the input to the manager 124 is a badge-related management request may issue such a request. The issue of such requests may be explicitly done by a human being via one or more computer interfaces, such as a GUI or a script. The request may be a one-time request or an scheduled request that is issued periodically and triggered by a timer. A request is first processed by a request analyzer 802 to create a corresponding management task. The task is then dispatched by a controller 804 based on the type of the request as well as timing of the request.

One exemplary management task is to design one's character badges for display or export For example, on an engagement system like TripAdvisor, each reviewer's earned badges may be displayed along with their profile to establish their reputation and lend credibility to their reviews. The badges to be designed are first retrieved from the databases 130 by the badge retriever 850. The badge designer 810 creates an information graphic that uses visual and/or verbal elements to encode one or more pieces of badge-related information, such as the type of badge and the strength. The designer 810 may use information, such as various visual design rules, stored in the knowledge base 140 to guide its design process. The resulted graphic is then handled by module 812 to be displayed directly or exported to another system. For example, the badge graphic may be sent to a physical device, such as a monitor, an electronic badge, or a head-worn display, to be shown. In another case, assume that a reviewer on TripAdvisor now wants to submit a review on Airbnb. She may want to export one or more character badges earned on TripAdvisor to Airbnb to establish her reputation. In this case, module 812 may export the graphic in one or more formats: a file, such as PNG or JPEG, a URL to an image, or a JavaScript to be embedded into a webpage.

Another exemplary management task is to allow a user to import one or more of her character badges from another system to update her profile on the current system. Using the above example, assume that now the TripAdvisor reviewer now logs onto Airbnb and wants to to import one or more of her TripAdvisor badges. In this case, the badge updater 808 first retrieves the profile of the user by 850 and then integrates the imported badges with her current profile. One of the exemplary implementation for merging the badges is similar to the trait aggregation process by 530 described earlier. For example, two badges are simply merged by taking the average of their strengths and other measures, if they are the same type (e.g., Insightfulness) and their other key properties, such as qualifying time and score are also similar. In case when two badges are the same type but other properties are too far apart, other criteria are examined, such as the qualifying score. The one with the higher qualifying score may be retained. The updated badges are stored in the databases 130 or sent to the badge composer 810 to update the badge display.

One exemplary verification task is to certify a person's certain characteristics for a certain purpose. For example, in a peer-to-peer lending platform such as Upstart and Lending Club, a potential lender may look up a borrower by asking the system to certify the borrower by one or more types of badges, such as Responsible. This is similar to FICA credit score certification. However, unlike a credit score, this present teaching uses one or more character badges to calculate a character score that certifies one's one or more desired characteristics or qualities. In this case, the verifier 820 calls the badge retriever 850 to retrieve the requested badges and their related information for the person to be certified. Depending on the one or more certification criteria, such as the qualification score of the earned badges or the associated confidence factor/probability score of associated traits must exceed a threshold, the verifier then computes an overall character score of person p:

$$Character\_Score ( p ) = {\sum }_{i = 1}^{K} S ( {b}_{i} ) \times {w}_{i}$$

Here the score S( ) of a badge bᵢ is determined by the certification criteria, such as the qualifying score of the badge, and the weights may be empirically defined by the system or interactively specified by the requester. Depending on a domain the character score may be associated with different types of badges. The computed character score and the associated badges are now provides in a certificate to the requester. Note that the certification may be requested by a person him/herself, just like in a credit score certification process, for his/her own use.

Another exemplary management task is to allow a user/admin to verify the integrity of certain content (text or images alike). Assume the underlying engagement system is Yelp and one user is submitting a new review. During the content submission, a management request on verifying the integrity of the content against the the author's character badges may be generated. This request is then processed to create a verification task. The task is routed to a verifier 820, which first retrieves the badge information of the author. It then checks how consistent the current content matches with existing character badges. The verification results are sent to a report generator 840 to be presented. The report generator may display the computed consistency metric along with the content. Such information is quite useful in one or more ways. One benefit is to prevent fraud. For example, if a user's identity is stolen and an importer tries to post a content out of the character of the original user, the inconsistency is then detected. Another benefit is to ensure the integrity of a user's character. If the same user tries to post content that is out of her usual character, she is then warned and may be at risk of losing her one or more character badges.

Another exemplary verification task is to verify whether a user tries to assume multiple identities. In this case, the verifier 820 calls the badge retriever 850 to retrieve the badge related information of the user under investigation and the users who are the most similar to the user based on their character badges or additional human traits. The similarities and the likelihood of the two or more people being actually the same person based on their similarities. Such information is then sent to the report generator to be reported 840.

Another exemplary management task is to analyze the health of the underlying engagement system as a whole based on its users' character badges and the changes in these badges. In this case, the badge summarizer 830 first creates a badge-based summary of selected or all users. The summary may reveal one or more types of statistics, such as the types of badges awarded and their distribution among users. Moreover, the statistics may also capture the changes in how people earn or lose badges over time. Based on the summary, the health explorer computes various badge metrics 831, which may be used to indicate the health of the engagement system. For example, for an online review site, the Quality metric measures how many Insightful badges have been awarded to how widely it is awarded. This metric may be an indicator of the review quality generated at the site. As a result, various metrics may be reported by the report generator 840 for a human user (e.g., system admin or community manager) to gauge the health of the underlying community and engagement system.

Another exemplary management task is to perform one or more management tasks periodically. In this case, a management trigger 806 associated with a timer 805 triggers different functional units to perform a scheduled management task. One such task may be to update one or more user's character badges using new data. The badge updater 808 generates a character badge request, which is then sent to the badge determiner unit 120 to update the badges. Note that in this process, a user may gain or lose one or more character badges depending on the new data. Another scheduled task may be the community summarization 830 and health metrics calculation 832 as described above.

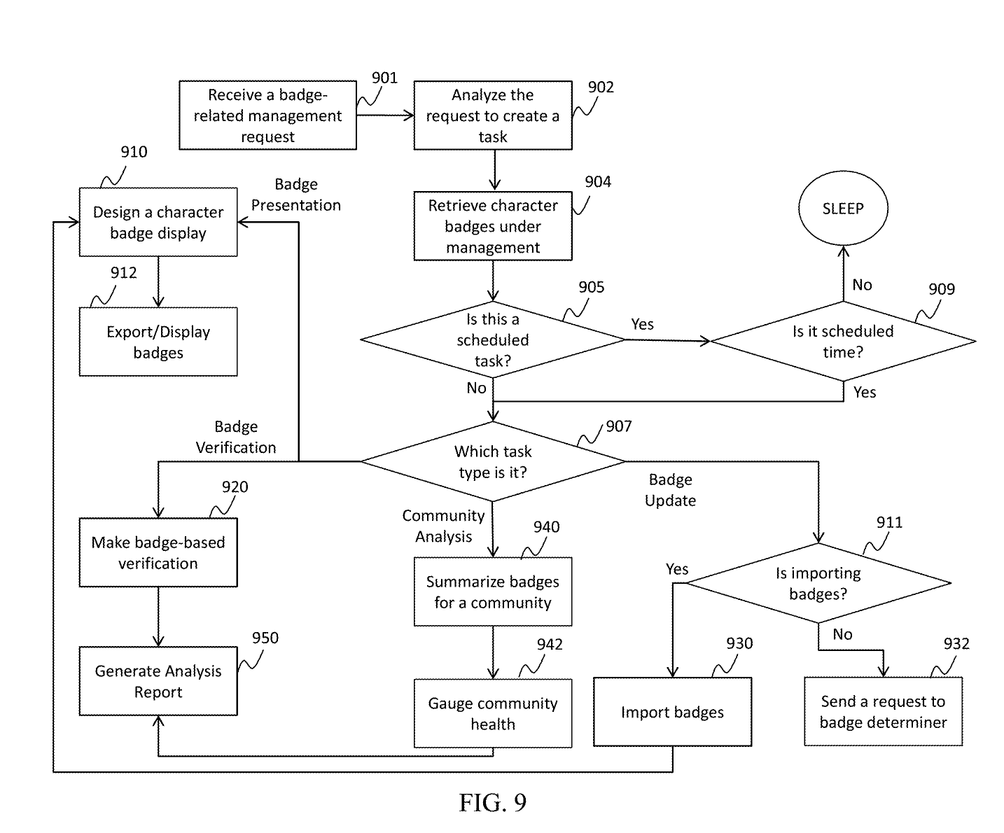

FIG. 9 is a flowchart of an exemplary process performed by a Character Badge Manager, according to an embodiment of the present teaching. FIG. 9 captures one or more process flows as how the character badge-based manager handles badge-related management requests. Starting with a badge-related management request received at 901, the request is processed and a corresponding management task is created at 902. Per the task description, relevant character badges (e.g., the badges to exported or analyzed) and associated information are then retrieved at 904. The process then checks whether the management task is a scheduled task at 905. If it is not, it then checks the type of the task at 907.

If the type of the task is to display one or more badges, a badge graphic is composed at 910. The composed graphic may also be exported if desired at 920.

If the task is to verify a particular piece of content or a user identity, the relevant information is then sent to be verified at 920. The verified results are then synthesized into a report at 950.

If the task is to update existing badges, it then checks whether this is a case of badge import at 911. If it is, the imported badges are then merged with the existing badges at 930. If not, a new character badge request is then created at 932 and will be sent to the badge determiner at 120 for further process.

If the task is to analyze a community, it first summarizes the character badges of people in that community at 940 and then use the results to gauge the community healthy at 942. The analysis results are then compiled into a report at 950.

On the other hand, if the task is a scheduled task at 905, it checks whether it has reached its scheduled time at 909. If not, the process sleeps until the time comes. Otherwise, it checks the task type to see which task is to he performed. The task handling then follows the process just described above. Details on several complex steps are provided below.

This step 910 takes one or more character badges as its input and outputs an information graphic that encode the badges. The designer first determines which badge information to be encoded. One or more approaches may be used to implement the content determination process: One exemplary approach is a template-based approach. In such an approach, one or more content templates are defined. For example, one template specifies the display of a badge mast include its type and strength, while it is optional to show its other related information, such as qualifying score. It is most likely the context may determine the templates. For example, in a context such as an online peer-to-peer lending system where one's reputation is regarded highly and critical to the success of the system, a template may specify the display of the badge not only must include the badge type and strength, but also the top-qualifying, traits and the dominate data sources used (e.g., one's data source or peer input) to derive the badges as evidence.

Once the badge content to be displayed is determined, it then decides on the actual visual design. There are one or more exemplary implementations of the design process, from a fully automatic approach to a hybrid human-driven approach. A fully automatic approach is to automatically choose a verbal/visual element to encode a badge and its related and then composes them together into a coherent information graphic. The composition process may follow the composition of an information art. In such an approach, design rules are used to guide the selection of lower-level visual elements, such as color, shape, and themes to encode different types of information. These lower-level visual elements are then composed to form a higher level information graphic. These visual elements are then composed together to form a coherent visual display. In the context of this present teaching, one exemplary set of design rules may be similar to the following:

Badge,type→Bar,color; Badge,strength→Bar.height;

BadgequalifyingScore→Bat.brightness;

Bar+Bar→Bars; Bars+Bar→Bars; Bars→Barcode.

These rules indicate that the color is used to encode a badge type, the height of a bar is used to encode the strength of the badge, and the brightness is used to encode the badge qualifying score. Once all badges are encoded, the next set of rules indicate one o more badge “bars” may then be put together to form an information graphic, such as a one-dimensional color bar code. Depending on the design needs, different rules may be used. For examples, instead of using a color to encode a badge type as in the above rule, one may use an image to encode a badge type. These rules and visual elements are stored in the knowledge base 140.

Alternatively, one exemplary implementation may use a hybrid human machine design approach. A human may he involved in the design process and guide the selection. For example, while the system decides to use a color to encode a badge type, it asks a human user to select the actual color to be used. This way, the system may decide on the high level design choices, while leave the human user to decide on certain design details.

Yet another alternative exemplary implementation is to let a human user drive the whole process interactive, from choosing an encode scheme to selecting a specific visual element, such as a color or texture to use.

At 920, since a person's character badges indicate the person's unique qualities and earned reputation, the badges may be used as a type of identity for one or more verification purposes. One verification task is to verify the content generated by a particular person. Such an verification not only benefits the author to be true to her/his character, but it also helps a system administor or community manager to verify the integrity of the engagement system and prevent potential fraud. Given a piece of content, such as a text writeup, this step computes how this piece of content is related to the author by one or more of the earned character badges or derived hybrid human traits. One exemplary verification formula is as following:

$$V ( c , p ) = {\sum }_{i = 1}^{K} distance ( {T}_{i} ( c ) , T ( {b}_{i} ) )$$

Here V( ) computes a verification score for content c generated by a person p. Assume that person p has obtained K badges, for every badge bᵢ, it computes the distance( ) between one or more traits derived from the content c and the traits used to determine bᵢ. Here function Tᵢ( ) derives the traits from the generated content c, and the trait derivation process is similar to what described in 512 except that it only derives the trait scores associated with badge bᵢ. Function T( ) retrieves the trait scores that are used to derive the badge. The distance function here may be implemented as an Education distance between two sets of trait scores. If the final V( ) score exceeds a certain threshold, feedback may be given to the author or a system administrator to alert of the discrepancies. If such discrepancies persist as the person generates more content, one or more most affected badges—where the discrepanicies are the biggest—may expire and be taken away. For a system administrator, such information or alert, is quite useful, as it might be a sign of account hi jacking and other potential frauds.

In the cases where one has not earned any badges yet, his/her hybrid human traits may be used to replace the traits associated with a badge in the above formula. The same verification may still be used to verify a user against the generated content. Unlike the situation described above, where increased discrepancies may cause the loss of earned badges, the discrepancies here may prevent a person from ever earning a badge.

In addition to verifying, a user by examining his/her generated content against his/her character badges, another type of verification is to check the identity of a user against other users based on their character badges. This use is also quite beneficial for a system administrator to ensure the integrity of an engagement system. For example, a user may want to maintain multiple identities in the same system, tins process may detect and alert the potential multiple identities of the same person. Given a user to be verified, this process first retrieves one or more people who are similar to the user under verification based on the similarity of their earned badges. After one or more people are retrieved, it then computes the verification score between the user p and each of the retrieved person p′. The verification is similar to the above, except that the distance is between two sets of trait scores from two people for all their N traits. Unlike the above verification, here the closer the distance is, the more likely that the two people might be the same person since it is difficult to find two people who have the similar set of fingerprints—hybrid human traits.

$$V ( c , {p}^{′} ) = {\sum }_{i = 1}^{N} distance ( {T}_{i} ( p ) , T ( {p}^{′} ) )$$

At 940, in an augmented peer-to-peer engagement system, each user now is characterized by one or more human traits and/or associated with one or more character badges. Together, these traits and character badges also define the characteristics of an engagement system, essentially a community, virtual or real. Thus, it is beneficial to summarize the characteristics of users in an engagement system and understand. Such characteristics.

The summarization process is to compute one or more statistic metrics based on the characteristics of users. Given a sample population, one or more metrics as following may be computed:

Diversity. This metric calculates the diversity of the characteristics in an engagement system, or a community for short. It may be estimated by the number of different badges that are awarded, and the number of people whom are awarded. The more types of badge are given and the more people are awarded, the more diverse it is. Unlike other community metrics used before, which mainly examines the activity patterns of people, such as the number of posts or likes, this metric not only measures the activity patterns, but also signal the characteristics of the people who are involved and active.

Quality. This metric estimates the quality of the content generated by the people in an engagement system. It may be estimated by the number of certain types of badges issued, such as the Insightful badge. Again, unlike previous systems, which rely on information such as simple user votes to estimate the content quality, this metric goes further to approximate the content quality based on both user behavior and the content characteristics such as its word use.

Polarity. Similar to the quality metric above, this one measures the overall discrepancies among the people in the engagement system (community) based on one or more of their character badges and/or derived hybrid human traits. For example, the polarity is small if most of people are high on their Agreeableness and there are many Positivity badges that have been awarded. This metric approximates another interesting characteristic of a community that has never been computed before. If the polarity value is too small, it may indicate the “deadliness” of the community; otherwise, it may signal potential disharmony in the community.

Integrity. It may also be useful to measure the integrity of a community by the number of certain character badges awarded. Character badges, such as Fair and Responsible, provide a good signal as what types of people are involved in a community.

Similar to above, additional metrics may be computed based on one or more types of badges awarded and are used to characterize the overall engagement system as a whole. Such information not only is useful for a system admin/community manager to better understand the people involved, but it also helps users (especially new users) of an engagement system to better understand who are involved.

At 942 given the summarization metrics described above and their changes over time, one (e.g., a system admin) may be able to examine the overall health of the underlying engagement system, or the community as a whole. For example, the degrading in Integrity and Quality metrics mentioned above, may be a sign of degrading community healthy. The swing in Polarity may also signal the changes in community health as well. Since every engagement system is different and may use one or more metrics to determine its health, one of the many exemplary implementations of this step is to let a user most likely a community manager or a system administrator) monitor the changes in various metrics, and define different types of health alerts. Such alerts may also be changed as the community evolves. For example, one such alert may be like:

IF Integrity<threshold1 AND Quality<threshold2 THEN alert

Unlike community health monitoring systems, which normally rely on metrics of user activities, the examiner disclosed here captures the health of a community based on the true characteristics of people involved.

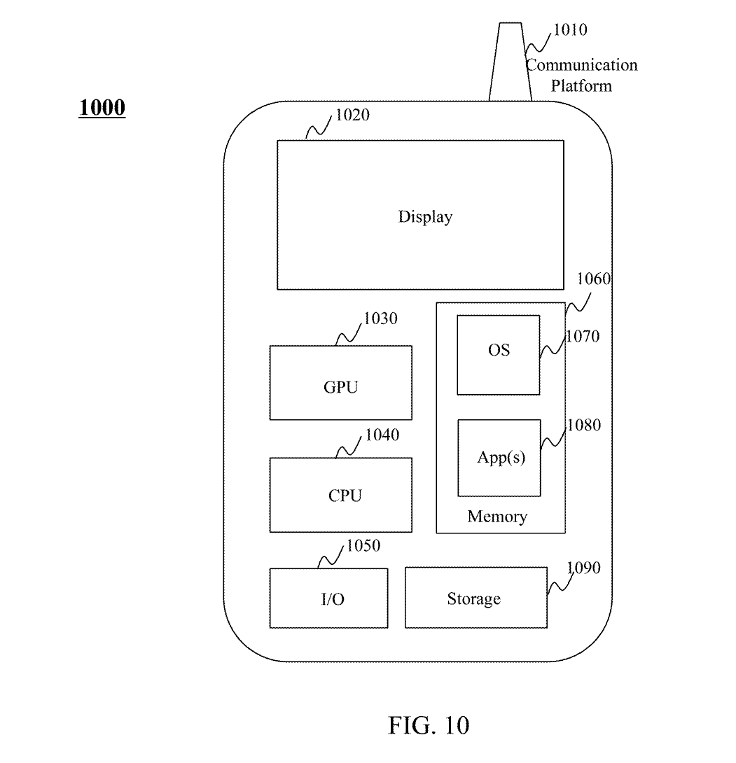

FIG. 10 depicts the architecture of a mobile device which can be used to realize a specialized system implementing the present teaching. In this example, the user device on which characterizing a user's reputation is requested and received is a mobile device 1000, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1000 in this example includes one or more central processing units (CPUs) 1040, one or more graphic processing units (CPUs) 1030, a display 1020, a memory 1060, a communication platform 1010, such as a wireless communication module, storage 1090, and one or more input/output (I/O) devices 1050. Any other suitable component, including but not limited to a system bus or a controller (not shown), may also be included in the mobile device 1000. As shown in FIG, 10, a mobile operating system 1070, e,g., iOS, Android, Windows Phone, etc., and one or more applications 1080 may be loaded into the memory 1060 from the storage 1090 in order to be executed by the CPU 1040. The applications 1080 may include a browser or any other suitable mobile apps for characterizing a user's reputation on the mobile device 1000. User interactions with the information about characterizing a user's reputation may be achieved via the 110 devices 1050 and provided to the Engagement Facilitation System 106 end/or other components of systems disclosed herein.

To implement various modules, units, and their functionalities described in the present disclosure, computer hardware platforms may be used as the hardware platform(s) for one or more of the elements described herein (e.g., the Engagement Facilitation System 106 and/or other components of systems described with respect to FIGS. 1-9). The hardware elements, operating systems and programming languages of such computers are conventional in nature, and it is presumed that those skilled in the art are adequately familiar therewith to adapt those technologies to characterizing a user's reputation as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

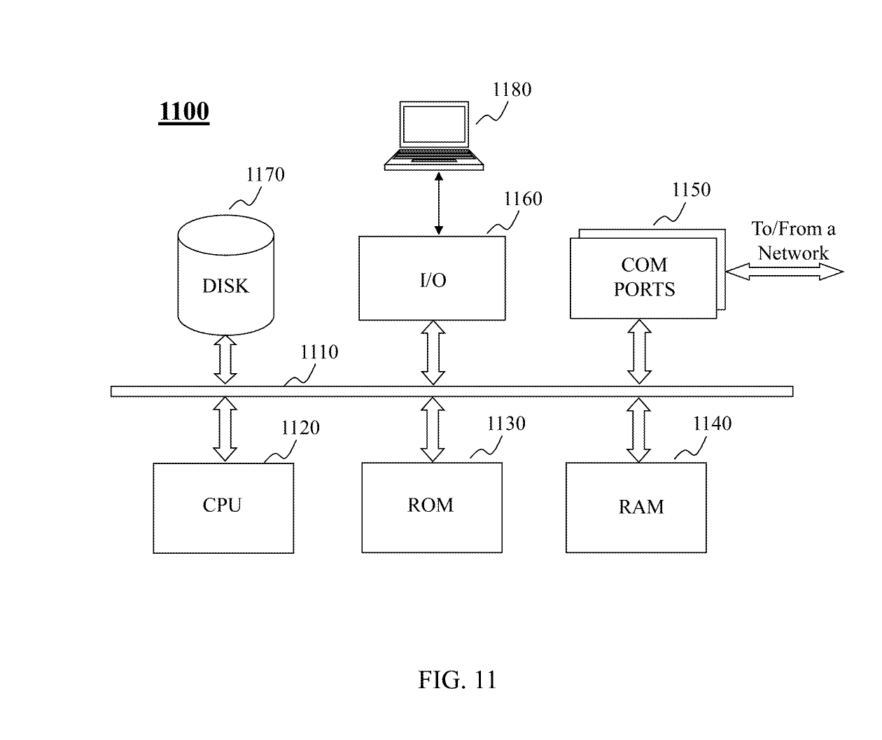

FIG. 11 depicts the architecture of a computing device which can be used to realize a specialized system implementing the present teaching Such a specialized system incorporating the present teaching has a functional block diagram illustration of a hardware platform which includes user interface elements. The computer may be a general purpose computer or a special purpose computer. Both can be used to implement a specialized system for the present teaching. This computer 1100 may be used to implement any component of the techniques for characterizing a user's reputation, as described herein. For example, the Engagement Facilitation System 106, etc., may be implemented on a computer such as computer 1100, via its hardware, software program, firmware, or a combination thereof. Although only one such computer is shown, for convenience, the computer functions relating to characterizing a user's reputation as described herein may be implemented in a distributed fashion on a number of similar platforms, to distribute the processing load.

The computer 1100, for example, includes COM ports 1150 connected to and from a network connected thereto to facilitate data communications. The computer 1100 also includes a central processing unit (CPU) 1120, in the form of one or more processors, for executing program instructions. The exemplary computer platform includes an internal communication bus 1110, program storage and data storage of different forms, e.g., disk 1170, read only memory (ROM) 1130, or random access memory (RAM) 1140, for various data files to be processed and/or communicated by the computer, as well as possibly program instructions to be executed by the CPU. The computer 1100 also includes an I/O component 1160, supporting input/output flows between the computer and other components therein such as user interface elements 1180. The computer 1100 may also receive programming and data via network communications.

Hence, aspects of the methods of characterizing a user's reputation, as outlined above, may be embodied in programming. Program aspects of the technology may be thought of as “products” or “articles of manufacture.” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications may enable loading of the software from one computer or processor into another. Thus, another type of media that may bear the software elements includes optical, electrical and electromagnetic waves, such as used across physical interfaces between local devices, through wired and optical land line networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IIR) data communications. Common forms of computer-readable media therefore include for example; a floppy disk, a flexible disk, hard disk, magnetic tape, an other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip OF cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

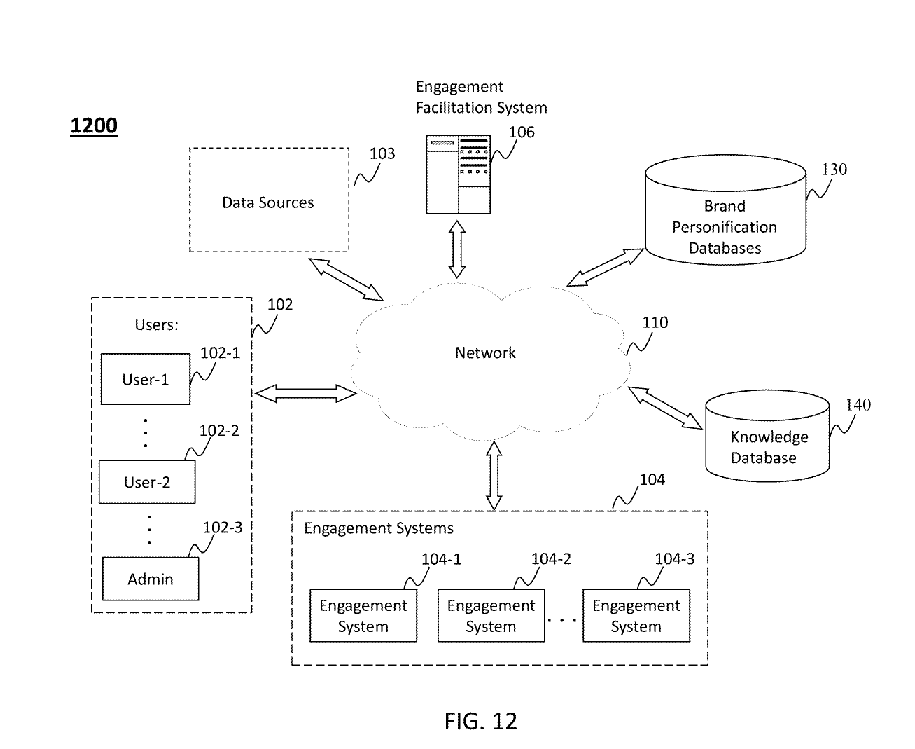

FIG. 12 is a high level depiction of an exemplary networked environment 1200 for brand personification, according to an embodiment of the present teaching. In FIG. 12, the exemplary networked environment 1200 includes one or more users 102, a network 110, an engagement facilitation system 106, databases 130, a knowledge database 140, engagement systems 104 which includes one or more engagement systems, and data sources 103. The network 110 may be a smote network or a combination of different networks. For example, the network 110 may be a local area network (LAN), a wide area network (WAN), a public network, a private network, a proprietary network, a Public Telephone Switched Network (PSTN), the Internet, a wireless network, a virtual network, or any combination thereof.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server, in addition, characterizing a user's reputation as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method, implemented on a machine having at least one processor, storage, and a communication platform connected to a network for characterizing a user's reputation, comprising:
obtaining, from one or more sources, information related to a plurality of users, wherein the information is obtained with respect to at least one type of online activity;
transforming the information into one or more human traits of the plurality of users wherein each human trait for each of the plurality of users is estimated based at least partially on the information related to the user and each human trait is associated with at least one score; and
estimating, with respect to a user's one or more human traits, a reputation of the user included in the plurality of users based on at least one score associated with each of one or more human traits of the user and at least one score associated with each of the one or more human traits of the plurality of users.

2. The method of claim 1, further comprising;
inferring at least one hybrid human trait of a user based on a plurality of human traits of the user, wherein each of the plurality of human traits is estimated based on one of a plurality of heterogeneous types of activities of the user; and
estimating reputation of the user based on the at least one inferred hybrid human trait of the user.

3. The method of claim 1, wherein the human trait of a user is inferred based on at one endorsement from a peer and the peer's estimated reputation and/or at least one human trait, wherein the endorsement includes a description about the user from the peer.

4. The method of claim 1, further comprising;
receiving a request from a first user for an instruction with respect to the first user's engagement with a second user;
generating the instruction based on the second user's estimated reputation and/or at least one human trait; and
providing the instruction to the first user as a response to the request.

5. The method of claim 1, further comprising:
receiving a request from a first user for a task involving a list of one or more users;
selecting one or more users based on the task, their estimated reputations, and/or at least one of their human traits;
ranking the one or more users and/or their associated information to generate a ranked list; and
providing the ranked list to the first user as a response to the request.

6. The method of claim 1, further comprising at least one of the following:
exporting a user's estimated reputation to a service provider; and
importing a user's estimated reputation from a service provider.

7. The method of claim 1, further comprising:
determining a first user m and a second user ID are associated with a same person by matching estimated reputations and the human traits associated with the first user ID to estimated reputations and/or human traits associated with the second user ID.

8. The method of claim 1, further comprising:
receiving an input from a user; and
determining whether the input is consistent with the user's previous inputs based on the user's estimated reputation and/or one or more human traits.

9. The method of claim 1, further comprising estimating a reputation of a human engagement system based on estimated reputations of users involved in the human engagement system.

10. The method of claim 9, farther comprising;
detecting one or more changes of the reputation of the human engagement system; and
estimating a health status of the human engagement system based on the detected changes.

11. A system having at least one processor, storage, and a communication platform connected to a network for characterizing a user's reputation, comprising;
a data input selector configured for obtaining, from one or more sources, information related to a plurality of users, wherein the information is obtained with respect to at least one type of online activity;
a human trait determiner configured for transforming the information into one or more human traits of the plurality of users, wherein each human trait for each of the plurality of users is estimated based at least partially on the information related to the user and each human trait is associated with at least one score; and
character badge determiner configured for estimating, with respect to a user's one or more human traits, a reputation of the user included in the plurality of users based on at least one score associated with each of one or more human traits of the user and at least one score associated with each of the one or more human traits of the plurality of users.

12. The system of claim 11 further comprising a hybrid human trait determiner configured for inferring at least one hybrid human trait of a user based on a plurality of human traits of the user, wherein each of the plurality of human traits is estimated based on one of a plurality of heterogeneous types of activities of the user, and wherein the reputation of the user is estimated based on the at least one inferred hybrid human trait of the user.

13. The system of claim 11, wherein the human trait of a user is inferred based on at least one endorsement from a peer and the peer's estimated reputation and/or at least one human trait wherein the endorsement includes a description about the user from the peer.

14. The system of claim 11, further comprising a character-based engagement facilitator configured for:
receiving a request from a first user for an instruction with respect to the first user's engagement with a second user;
generating the instruction based on the second user's estimated reputation and/or at least one human trait; and
providing the instruction to the first user as a response to the request.

15. The system of claim 11, further comprising a character based engagement facilitator configured for:
receiving a request from a first user for a task involving a list of one or more users;
selecting one or more users based on the task, their estimated reputations, and/or at least one of their human traits;
ranking the one or more users and/or their associated information to generate a ranked list; and
providing the ranked list to the first user as response to the request.

16. The system of claim 11, further comprising a character badge manager configured for at least one of the following:
exporting a user's estimated reputation to a service provider; and
importing a user's estimated reputation from a service provider.

17. The system of claim ii, further comprising a character badge manager configured for:
determining a first user ID and a second user ID are associated with a same person by matching estimated reputations and/or human traits associated with the first user ID to estimated reputations and/or human traits associated with the second user ID.

18. The system of claim 11, further comprising a character badge manager configured for:
receiving an input from a first user; and
determining whether the input is consistent with the first user's previous inputs based on the first user's estimated reputation and/or one or more human traits.

19. The system of claim 11, further comprising a character badge manager configured for estimating a reputation of a human engagement system based on estimated reputations of users involved in the human engagement system,

20. The system a claim 19, wherein the character badge manager is further configured for:
detecting one or more changes of the reputation of the human engagement system; and
estimating a health status of the human engagement system based on the detected changes.
